(19) United States
(12) Patent Application Publication
(10) Pub. No.: US 2010/0080537 A1
(43) Pub. Date: Apr. 1, 2010

(54) METHOD AND DEVICE FOR SYNCHRONIZING DIGITAL SOUND WITH IMAGES ON CINEMATOGRAPHIC FILM

(76) Inventors: Hendrik Berend TIMMERMAN, Neuvic-Entier (FR); Torulf HENRIKSEN, Oslo (NO)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/496,845

(22) Filed: Jul. 2, 2009

(30) Foreign Application Priority Data
Jul. 4, 2008 (NO) 20083039

(51) Int. Cl. H04N 5/91

(52) U.S. Cl. 386/104; 386/E05.003

(57) ABSTRACT

Device and method for synchronizing digital sound with images on cinematographic film. The sound is represented by sound data and the images are represented by image data. The device comprises a sampling device for sampling a stream of sound data, a memory device for storing the sampled sound data, and a transmitting device for transmitting the sampled sound data in synchronization with transmitting the image data.

The invention regards a method for synchronization digital sound with analogue images on cinematographic film.

When producing cinematographic film the sound and the pictures/images are traditionally manufactured independently and then combined to produce the final film comprising both pictures and sound. The sound is recorded on a sound negative film, while the images are recorded onto an intermediate negative film. The sound negative only contains the optical sound information and the intermediate negative only the image information. To obtain the final product, the two negative films must be brought together and be copied onto a positive print film which can be projected in the cinema.

At the combination stage, it is important that the sound and the images are synchronized in order to assure a lipsync projection.

The synchronization is currently done manually by an operator looking on the two negatives and lining them up to get the correct synchronization. This is generally done by the operator visually detecting a “beep” in the analogue sound track, which is an easily recognisable burst in the sine wave that should be aligned with the countdown number “2” on one of the image frames in the leader of the film.

U.S. Pat. No. 4,600,280 describes a prior art system for recording sound only on motion picture film.

U.S. 5,639,585 describes a system for photographically recording multiple audio formats (digital and optionally also analogue) onto the same negative film.

Recently, there have been developed real-time (24 frames per second) film recorders/printers which combine the image and sound recording phase into one recording session. This, however, requires the system providing the images and the system providing the sound information to be synchronized at the time where the film is exposed with the image and sound information.

The object of the invention is to provide a method for synchronizing digital sound with analogue images on cinematographic film in real-time applications without the need for manual handling and without having to encode the sound signal.

The object of the invention is achieved by means of the features of the patent claims.

In one embodiment, the method for synchronizing digital sound with analogue images on cinematographic film, the sound being represented by sound data and the images being represented by image data comprises the steps:

sampling a stream of sound data,
storing the sampled sound data,
transmitting the sampled sound data in synchronization with transmitting the image data.

The sound data may be digital or analogue data, and may be in an encoded and/or compressed format. Examples of (encoded) sound formats are Dolby Digital, Digital Theatre Systems (DTS), Sony Dynamic Digital Sound (SDDS), etc. A number of sound data sets may represent the film.

The image data can be any kind of digital or analogue image data, such as a High definition TV (HDTV) picture sequence, a sequence of pictures scanned from a motion picture film/cinematographic film by means of a full frame digital scanner, a digitally created digital film (e,g, created on a computer), etc, which are adapted for being recorded/printed or projected/transmitted in synchronization with corresponding sound.

The stream of sound data is sampled by a sampling device. This may be embodied by a processing device storing samples/parts of the sound data stream in a memory device. The memory device may be integrated in or connected to a processing device such as a computer. The data are stored in the same format as the original sound format, i.e. maintaining any encryption or encoding.

The sampling rate is adjusted to the sound stream requirements. Analog sound is typically sampled with 96 kHz. Dolby Digital lies in the magnitude of 800 kHz.

During the sampling, the data may be analyzed and relevant information recorded. Information regarded as relevant may for example be characteristics regarding the quality of the data and/or information relevant for the synchronisation. For example may information of which samples of sound data that contain obvious or possible defects or artefacts be stored or the relevant samples/data may be marked/flagged electronically for later recognition and compensation. Also, the location in the data stream/file of the “beep” or other characteristics indicating the start of the sound can be recorded and marked in similar ways.

In the case that there are more than on set of sound data, each of the sound data sets may be sampled separately and stored as separate sampled sets.

In one embodiment the sampled data may be further encrypted or encoded in order to secure the data and prevent any unauthorized copying. The data can be decrypted/decoded during or prior to transmitting the sound and image data or during the imaging of sound on a photosensitive medium.

The sound data and the image data may be transmitted to one or several imaging devices for creating an image on a photosensitive material such as a positive or negative film strip or for direct viewing. The imaging device may be an image projecting device or other kind of light modulating device for modulating light from a light source, for example a DMD (digital micromirror device), possibly as part of a DLP device (digital light processing), a transmissive LCD device or a reflective LCD device, etc. The light modulating device may be a digital full frame device (i.e. able to display all picture lines simultaneously). The light modulating device may be of a type which modulates all three primary colours (red, green, blue, (RGB)) or the device may comprise three light modulating units, each able to modulate one of the three primary colours.

The synchronization of the transmittance of the sampled sound data and the image data may be performed by a processing device. The synchronization may be performed by using characteristics of the different data signals, for example recognizing a “beep” in the sound signal which is intended for being aligned with a certain image frame on the film/photosensitive medium. If such characteristics are recorded during the sampling phase, this information can be retrieved and used for the synchronisation.

The processing device may also be adapted for processing input image data. The input image data may have any kind of displayable image format, digital or analogue, such as computer graphics format etc. Preferably the source material is HDTV or other full frame digitally represented film. The picture representation may be either a positive or a negative representation. The processing electronics and software may be adapted for processing both digital and analogue data, and comprises e.g. AD-converters for converting an analogue signal to a digital signal for further processing.

The processing device may further control the imaging device(s), for example according to known protocols/standards to give the correct modulation of light to be projected onto the photosensitive material. The processing of the input image data preserves the representation of a motion picture in such a way that the number of frames per time unit in the original motion picture corresponds to the number of projected frames per time unit. This provides a very efficient transference of the film, as there is no need for complicated interpolation procedures. The projected pictures may be either positive or negative according to the desired use of the product.

The invention will now be described in more detail by means of examples and with reference to the accompanying figures.

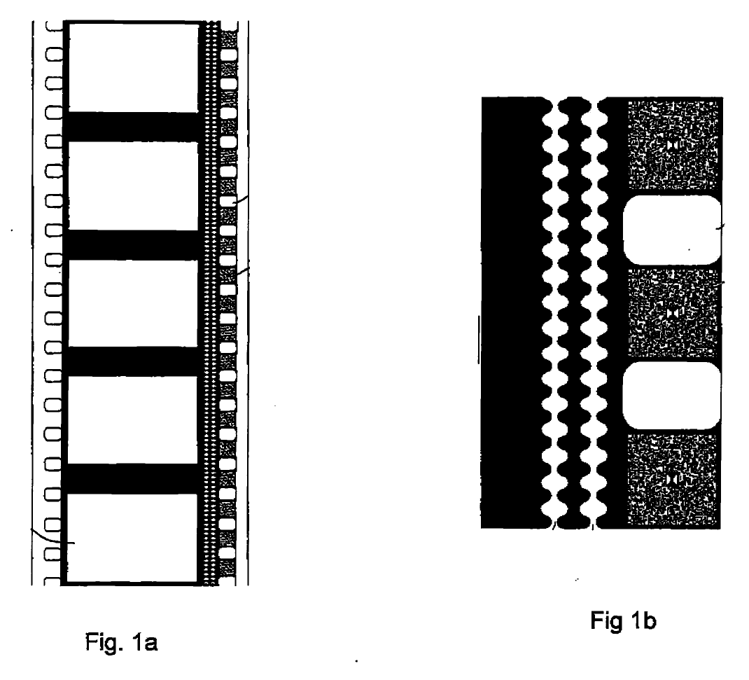

FIGS. 1a and b show examples of sound information represented on film.

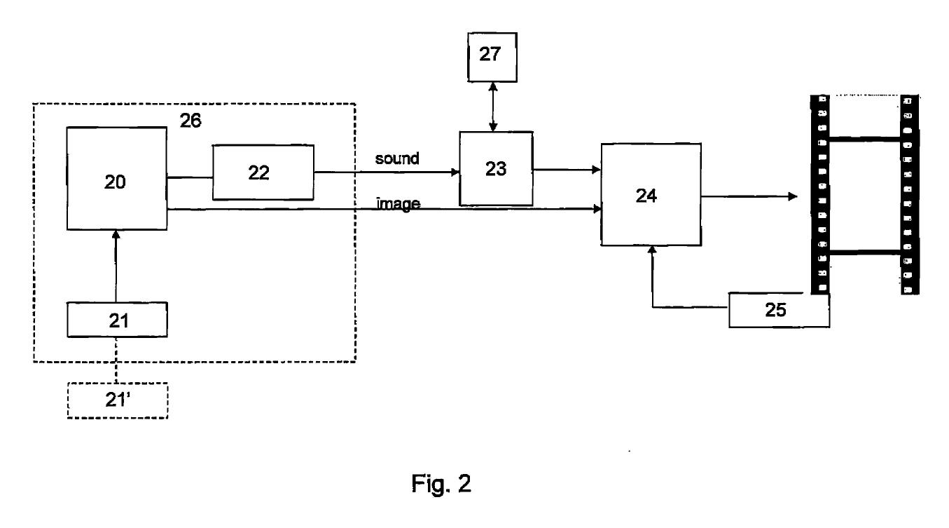

FIG. 2 shows a block diagram of one embodiment of the invention.

FIG. 1a shows an example of a regular film strip 10 for cinematographic (motion picture) film. The film strip carry optical representations of different sound formats. FIG. 1b shows a detail of the film strip of FIG. 1a. The film strip 10 comprises sprocket holes 11 and image frames 15 of which constitute the motion picture film. Between the image frames 15 and the sprocket holes 11, there are two tracks 13, 14 of analogue sound representation, for example analogue SVA or dual-bilateral monophonic tracks. Between the sprocket holes 11 there are arranged arrays of symbols 12 which represents Dolby Digital soundtrack.

The optical analogue sound track can be considered as the basic sound track of cinematographic film. It was the first form of optical sound for cinematographic film in history and is still in use. Even if digital sound systems are used during cinema projection, the optical analogue sound track will serve as backup in case a digital sound decoder fails. The analogue sound track generally comprises a so called “beep” signal, which is commonly a 1 kHz sine wave burst that is used to synchronize the images with the sound track. The “beep” should be aligned with the countdown number “2” on one of the image frames in the leader of the film. Digital sound have similar synchronization features, for example comprises Dolby Digital Sound two white and two black arrays marking that the first image will start in two seconds.

Traditionally the synchronizing has been performed manually by an operator inspecting the film visually and aligning manually, but there have been a long felt need for automatic synchronization. The synchronization may be performed automatically by means of a processing device analyzing the sound and image data for characteristics to be aligned on the film.

FIG. 2 shows a block diagram of one possible embodiment of the invention for recording Dolby Digital Sound.

Sound and image data are comprised in data device 26 which may comprise data storage 21 and/or a processing device 20. Alternatively, the data storage 21′ may be an external device connected to the data device 26. The data device 26 may comprise further processing devices 22, for example a Dolby CA-10 hardware which generates the signal for digital sound to be recorded on the film.

The sound signal is transmitted as a data stream from the data device 26 and a sampling device 23 samples the sound data and stores the sampled data in a memory device 27. The memory device may be integrated in or connected to the sampling device 23. The sampling device may be controlled by the processor 20 of data device 26 or comprise a separate processor.

The sampled sound data comprised in memory device 27 is then transmitted by a transmitting device (not shown) to an imaging device 24. The transmitting of the sampled sound data may be controlled by a processor in the imaging device 24.

Simultaneously to transmitting the sampled sound data, the image data is transmitted to the same or a different imaging device (not shown). The synchronization of the transmitting of the sound data and image data may also be controlled by the processor in the imaging device 24 based on recorded synchronization data.

In order to ensure correct recording of sound and image on the film, a sprocket sensor 25 may be arranged which senses the movement and/or position of the film and inputs the sensor data to the data device 26 or other processing device controlling the synchronization of the film/image/sound.

1. Method for synchronizing digital sound with images on cinematographic film, the sound being represented by sound data and the images being represented by image data, characterised in that it comprises the steps:
sampling a stream of sound data,
storing the sampled sound data,
transmitting the sampled sound data in synchronization with transmitting the image data.

2. Method according to claim 1, characterised in that the sound data are digital data.

3. Method according to claim 1, characterised in that the sound data are encoded and/or compressed data.

4. Method according to claim 1, characterised in that a number of sound data sets represent the film, and that each of the sound data sets are sampled.

5. Method according to claim 1, characterised in that the sound and/or image data are processed by a processing device.

6. Method to claim 1, characterised in that the sampled sound data and image data are transmitted to at least one imaging device at the same time.

7. Device for synchronizing digital sound with images when transferring onto cinematographic film, the sound being represented by sound data and the images being represented by image data, characterised in that it comprises a sampling device for sampling a stream of sound data,
a memory device for storing the sampled sound data, and
a transmitting device for transmitting the sampled sound data in synchronization with transmitting the image data.

8. Device according to claim 7, characterised in that the sound data are digital data.

9. Device according to claim 7, characterised in that the sound data are encoded data.

10. Device according to claim 7, characterised in that a number of sound data sets represent the film, and that each of the sound data sets are sampled.

11. Device according to claim 7, characterised in that the sampled sound data and the image data are transmitted to an imaging device.

12. Device according to claim 7, characterised in that it comprises a processing device.

13. Device according to claim 7, characterised in that it comprises an imaging device.
